(19) United States
(12) Patent Application Publication
(10) Pub. No.: US 2006/0161356 A1
(43) Pub. Date: Jul. 20, 2006

(54) Device for detecting the nature of a blow and measuring its force, method for using same and use thereof for refereeing a sport

(76) Inventors: Michel Desroses, Torcy (FR); Christian Venkiah, Paris (FR)

Correspondence Address: JORDAN AND HAMBURG LLP, 122 EAST 42ND STREET, SUITE 4000, NEW YORK, NY, 10168, US

(21) Appl. No.: 10/522,224

(22) PCT Filed: Jul. 11, 2003
(86) PCT No.: PCT/FR03/02186

§ 371 Date: Dec. 8, 2005

(30) Foreign Application Priority Data
Jul. 24, 2002 (FR) 02/09358

(51) Int. Cl. G01L 3/00

(52) U.S. Cl. 702/41

(57) ABSTRACT

The invention concerns a device and a method for detecting the nature of a blow and for measuring its force. The device includes a first sensor integral with a stationary or mobile target for detecting whether the target has been impacted by a mobile body and a second sensor intergral with the mobile body for detecting whether the mobile body grazes the target or strikes it. The moving body includes a material highly permeable to a magnetic field and the target includes means for generating a magnetic field in its vicinity, the magnetic properties of the target being detected by using a magnetic field detector. The invention is useful for refereeing a combat sport.

### FIELD OF THE INVENTION

The invention relates to the supplying of an electronic device for scoring points in competitive sports, and notably combative sports.

For instance, considering the case of taekwondo, a martial art sport which is approved for the Olympic games, the only electronic part to this day concerns the scoring of points, entrusted to the corner referees, with the help of levers. Two levers must be simultaneously activated in order to validate any point.

A taekwondo fight brings together two competitors on a square-shaped area measuring about 7×7 metres. A corner referee takes position at every corner of this area. There is also a central referee.

Each competitor wears a breastplate, differing in colour, as well as a helmet. The two helmets may have the same or different colours.

The aim of the game is to fight one's opponent by striking the greatest possible number of blows (with the foot or the fist), or by knocking him out. Blows with the fist are only allowed on the breastplate, whereas kicks are allowed on the parts which are protected by the helmet and the breastplate.

The invention thus relates to a device for the detection of the nature of a blow and for measuring its strength. Moreover the invention relates to a process for operating this device, as well as its use for referees in a sport, and more particularly a combative sport.

### BACKGROUND OF THE INVENTION

Many documents describe devices for measuring blows as delivered in a contact sport.

For instance, document GB-A-2 321 003 describes an apparatus for monitoring blows as delivered in a contact sport such as boxing. The device comprises palpating means which are included in a glove for palpating the strength of a blow and which may be piezoelectric means which record blows and transform their pressure into an electric signal. The latter reaches a radio transmitter which transmits a signal to receiver means. The receiver means deliver an input signal to a transducer such as a computer which may determine and record sundry variables of the blows such as their strength. The palpating means may be situated in a helmet rather than in a glove.

Document EP-A2-0 222 640 describes a device for measuring blows which comprises a transducer in order to transform the pressure into an output electric signal. This transducer is placed in a protecting accessory for shielding a part of the human body. More particularly the transducer is a piezoelectric transducer which transforms pressure into an analogue output electric signal.

Document U.S. Pat. No. 3,866,909 describes a uniform for karate fighters including a plurality of pockets which are assembled at critical positions of the vulnerable parts of the human body (solar plexus, Adam's apple, stomach, liver, &c). Each pocket contains a fluid and breaks beyond a given strength of a blow inflicted on it. The strength of the blow is neither measured or recorded.

Document U.S. Pat. No. 5,184,831 describes pressure-sensitive materials and devices for electronically recording points in karate matches. The pressure-sensitive material includes a first conductor material such as a plastic material which is impregnated with conductor particles and which comprises fingers enclosed in slits and supported by a foam insulating material. When a force is brought to bear on the device, the fingers move and come into contact with an opposing conductor sheet. An electric circuit is thus formed and may transmit an electric signal. This signal is transmitted by a radio transmitter with a given frequency.

Document DE-A-2 741 090 relates to a device for indicating the state of a match and which includes transmitters and a receiver. The transmitters are located on gloves, masks, &c.

Documents EP-A1-1 033 152 and EP-A1-1 090 661 describe a device for measuring blows and in particular a measuring jacket for taekwondo. This device comprises a hollow space filled with gas, which may be compressed, and with an opening through which the gas escapes outside during compression of the hollow space after a blow. The gas flow may be measured.

Document WO 90/09218 describes a garment for contact sports comprising a pressure-sensitive device which emits a signal when struck by a blow delivered with a strength below or equal to a threshold strength. The pressure-sensitive device comprises two separate membranes with electric conductor means, these membranes coming into contact with one another when a strength at least equal to a threshold strength is brought to bear on the device, thus forming between the membranes an electric circuit which emits a signal.

Document FR-A-2 612 411 describes a device for signalling impacts by means of a radio-electric transmission during a karate fight. Blows are identified by means of push button contactors which emit an electric impulse.

U.S. Pat. No. 5,334,831 describes a device for detecting and quantifying ferrous debris in a fluid. This is a traditional process based on magnetic sensors. The latter's drawback is that they are highly sensitive to disturbances. An optical sensor is used for detecting particles which are caught in a magnetic field. The device takes advantage of the Faraday effect. With the help of this device one may regulate the purity of fluids as used in industrial pneumatic and hydraulic systems.

U.S. Pat. No. 4,527,153 describes a process for detecting the course of an article as equipped with an element. This element is a permanent spherical element enclosed in a capsule of indifferent shape, in such a manner as to leave some play (in the region of the sphere's diameter) in order to allow the sphere to move slightly. The detection area (a few cubic metres) is traversed by an alternating magnetic field, in order to make the sphere vibrate in its capsule. This motion generates an additional magnetic field which may be detected by a magnetic field sensor. Another approach is based on the detection of the sound as produced by the sphere when vibrating in its capsule, with the help of a microphone. Such a device may be used for the prevention of theft in shops.

U.S. Pat. No. 6,232,879 describes a device for the detection in a given area of the crossing of an article as equipped with an element. The article is itself equipped with a wire with a diameter below 100 μm. The wire is sized in such a manner that, when subjected to an electromagnetic wave, it starts resonating and responds with its own electromagnetic wave. This wave has the same frequency as the emitted wave. The magnitude of the back wave is altered by a lower frequency magnetic field. Thus the receiver receives an amplitude modulated electromagnetic wave. This is an anti-theft device for shops. The system detects the presence of a metal wire with specific properties in a very important area (considering electromagnetic waves may cover vast surfaces). The material's high frequency electromagnetic resonance properties are thus made use of, together with the potential for modulating the material's impedance with the help of a magnetic field.

In some documents of the prior art one may find a description of devices for detecting and/or measuring impacts. None of these prior art devices addresses the surprising new problem of detecting the nature of a blow, that is to say whether the blow is delivered by the foot or by the hand. None of the hereabove cited documents considers the novel problem of determining whether a given part of the human body has touched or even moved near another part of a human body. Thus the problem of knowing whether a player has kicked or stricken a blow with the fist at part of another player's body, or whether a player has even skimmed or lightly touched another player is in no way mentioned nor suggested in the prior art. Now this question may turn out to be very important, notably for the referees of different sports such as combative sports or even sports such as soccer, for instance for ascertaining free kicks.

### SUMMARY OF THE INVENTION

The invention relates to a sensor which is integral with a mobile body as associated with a possibly mobile target, said sensor fulfilling the task of indicating whether the mobile body lightly touches the target or strikes it. The mobile body is made of a material which is largely permeable to the magnetic field and the target comprises means which create a magnetic field in its neighbourhood, the target's magnetic properties being detected with the help of a magnetic field sensor.

The material which is permeable to the magnetic field has an initial permeability of 60,000 and a maximal permeability of 240,000, said material being chosen within the group made up of ferromagnetic alloys having a high magnetic permeability and a low coercive force.

The magnetic field permeable material is an alloy of the Mumetal® or Permalloy® type as marketed by the Goodfellow company.

The variations in the magnetic properties of the target as induced by the magnetic field permeable material are detected by a magnetic field detector which is made up of an induction coil, an oscillating circuit, a rectifier and a comparator.

The invention also relates to a sensor A which is integral with a target whose task is to indicate whether the target is stricken and to give an electric image of the magnitude of the blow as delivered. It is made up of a matrix comprising a plurality of capacitors. This capacitor matrix may be partially deformed under the influence of an impact to yield a variable conductance.

The capacitor matrix is made up of a first matrix, M, with a plurality of plates P1, P2, P3, . . . Pn of a conductor metal which are interconnected, and of a second matrix, M′, with a plurality of plates P′1, P′2, P′3, . . . P′n of a conductor metal which are interconnected, said plates P1, P2, P3, . . . Pn facing said plates P′1, P′2, P′3, . . . P′n and being separated therefrom by a variable distance in order to form capacitors whose distance between plates may vary under the influence of an impact.

According to the invention a device for detecting the presence of an impact by a mobile body onto a target and for measuring its strength comprises a sensor A which is made up of a variable capacitor, and a sensor B which is made up of a variable inductance.

The invention moreover relates to a process for detecting the nature of a blow onto a target, and for measuring its strength, such that the presence of a mobile body near or on the target is detected through the creation of a magnetic field on the target, and the magnetic field is varied with the help of the mobile body in order thus to obtain a variable inductance with the help of the inventive device, characterised in that the strength of the blow is measured with the help of said device, the relevant information about capacity variation being on the one hand memorised in a 16 bit register, and on the other hand the relevant information about inductance variation being memorised with one bit in a low level latch if the mobile body is present and a high level latch if the mobile body is absent.

Data concerning information on capacity variation and information on inductance variation are transmitted in the form of signals by radio waves to a receiver which is connected to a computer.

The inventive device is used by the referees of combative sports and more particularly for taekwondo.

### DETAILED DESCRIPTION OF A PREFERRED EMBODIMENT OF THE INVENTION

The following description will be made with a combative sport, or taekwondo, in mind, but it will be clear to art specialists that the invention is not limited to this embodiment and that it may be used in other sports or even in various fields beyond sports.

The invention will be explained in greater detail with the help of the appended drawings, wherein:

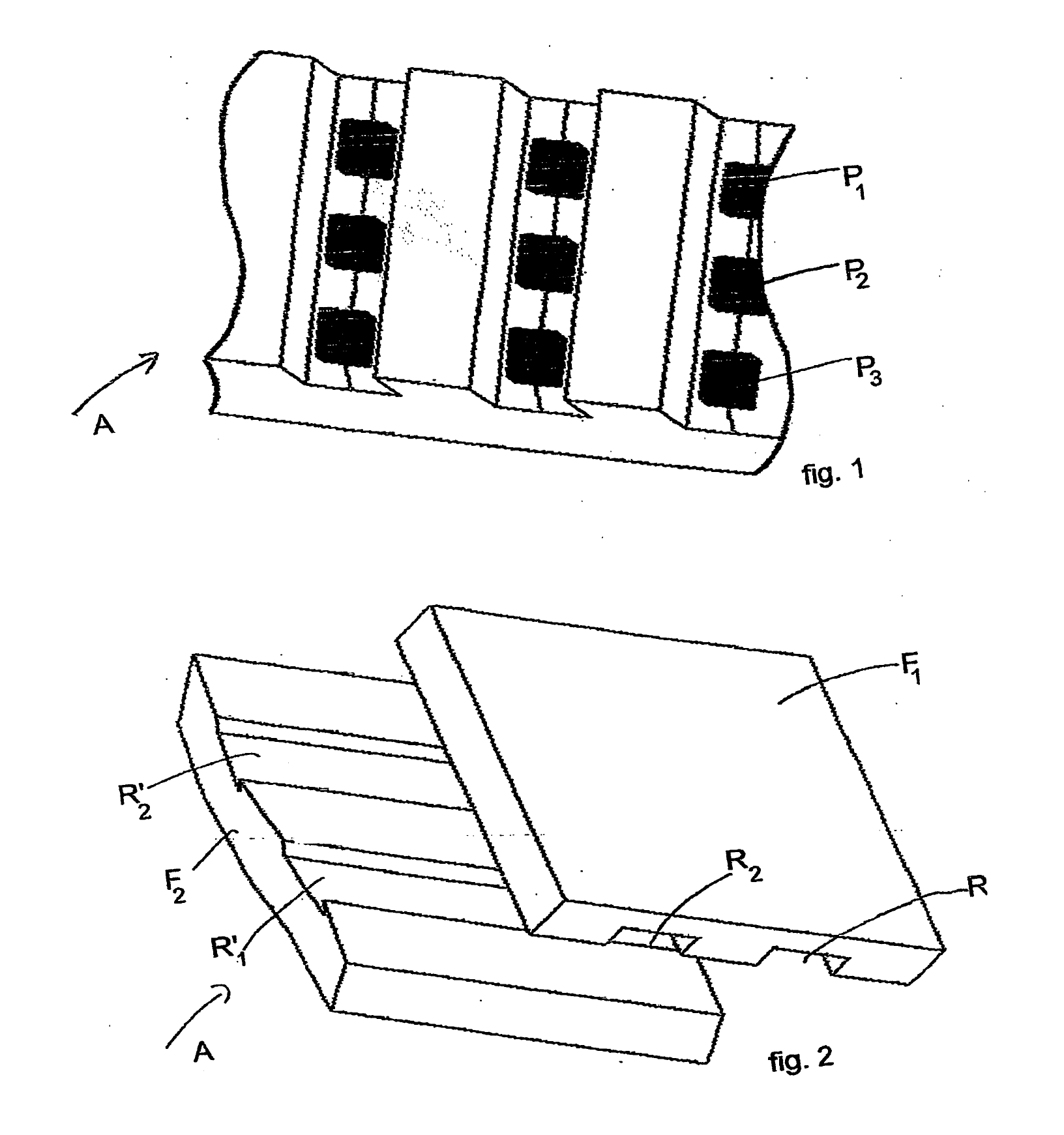

FIG. 1 is a perspective drawing showing the armatures as embedded in a foam sheet and forming the inventive sensor A;

FIG. 2 is a perspective drawing showing the foam sheets as opposed to each other, forming sensor A of FIG. 1;

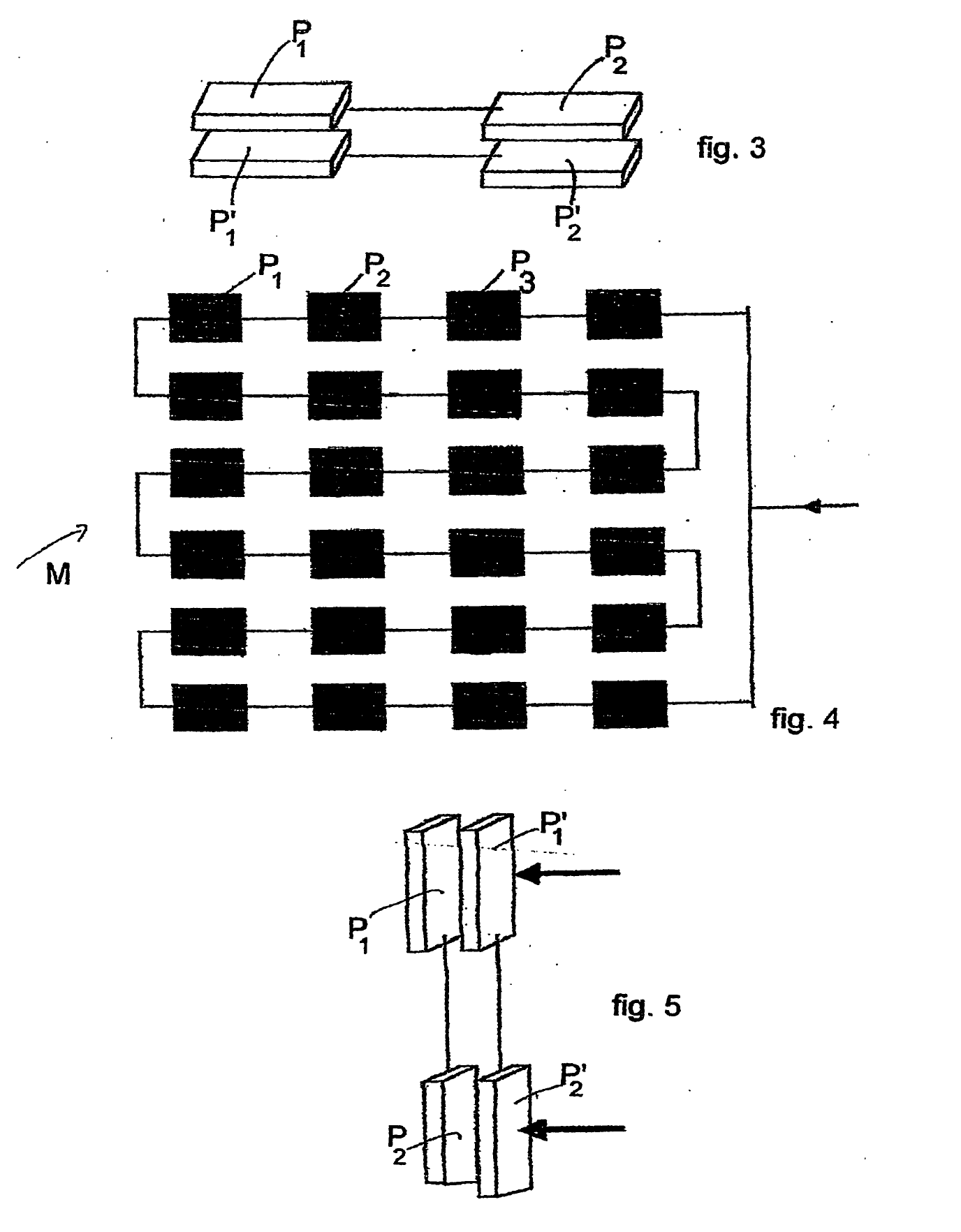

FIG. 3 is a view of capacitors as formed in sensor A of FIG. 1;

FIG. 4 is a view showing the interconnection of capacitors as in FIG. 3;

FIG. 5 is a representation of the deformation of capacitors in sensor A;

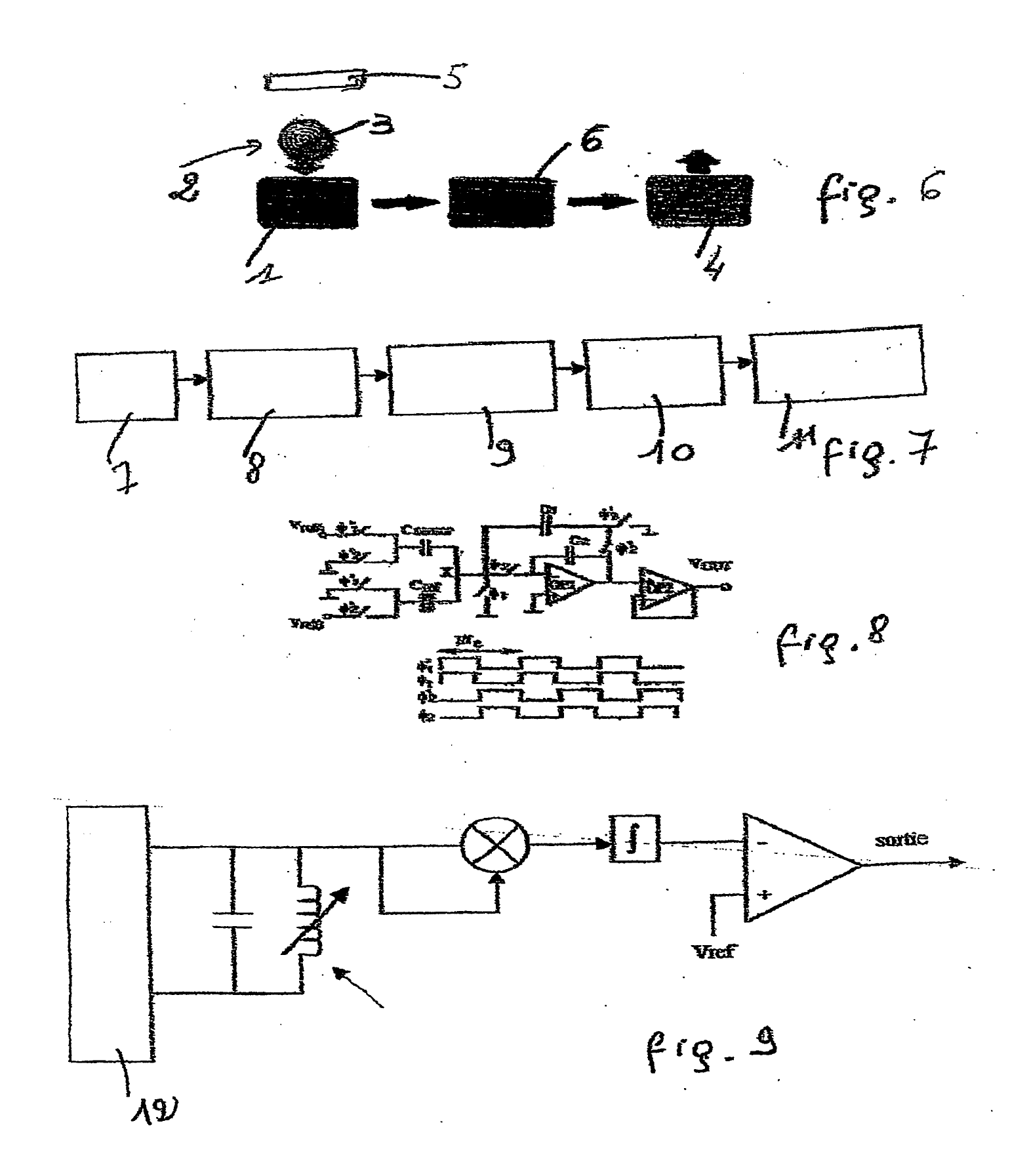

FIG. 6 is a diagram showing the oscillator-amplitude variation detector of sensor B;

FIG. 7 is a diagram showing the acquisition chain for the capacity variation;

FIG. 8 represents the interface of the load/voltage converter;

FIG. 9 is a diagram showing the connection between the oscillator and the comparator output;

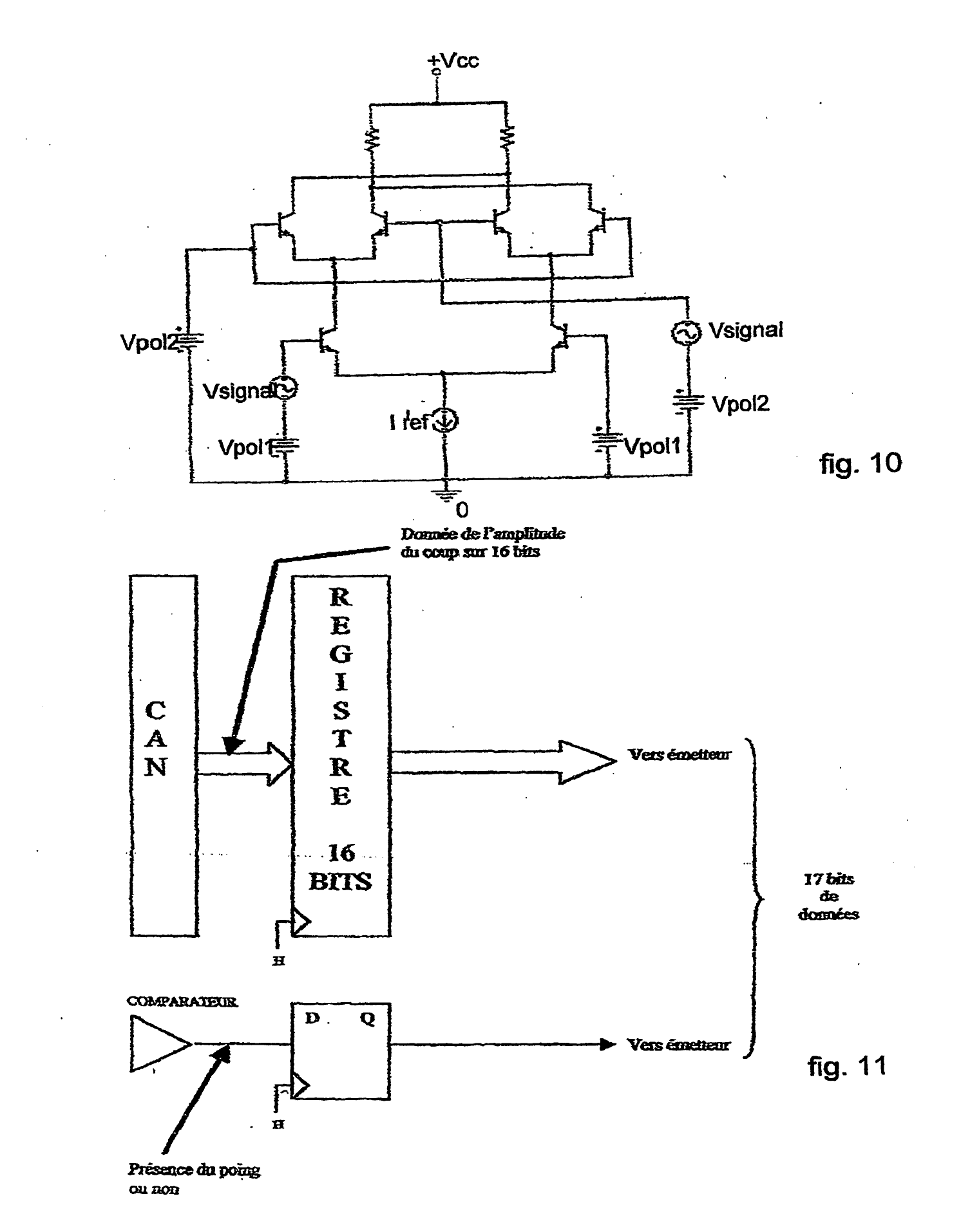

FIG. 10 is a diagram of a Gilbert cell as used for the multiplier;

FIG. 11 is a diagram showing the preparation of data;

FIG. 12 is a diagram showing the sending out of data;

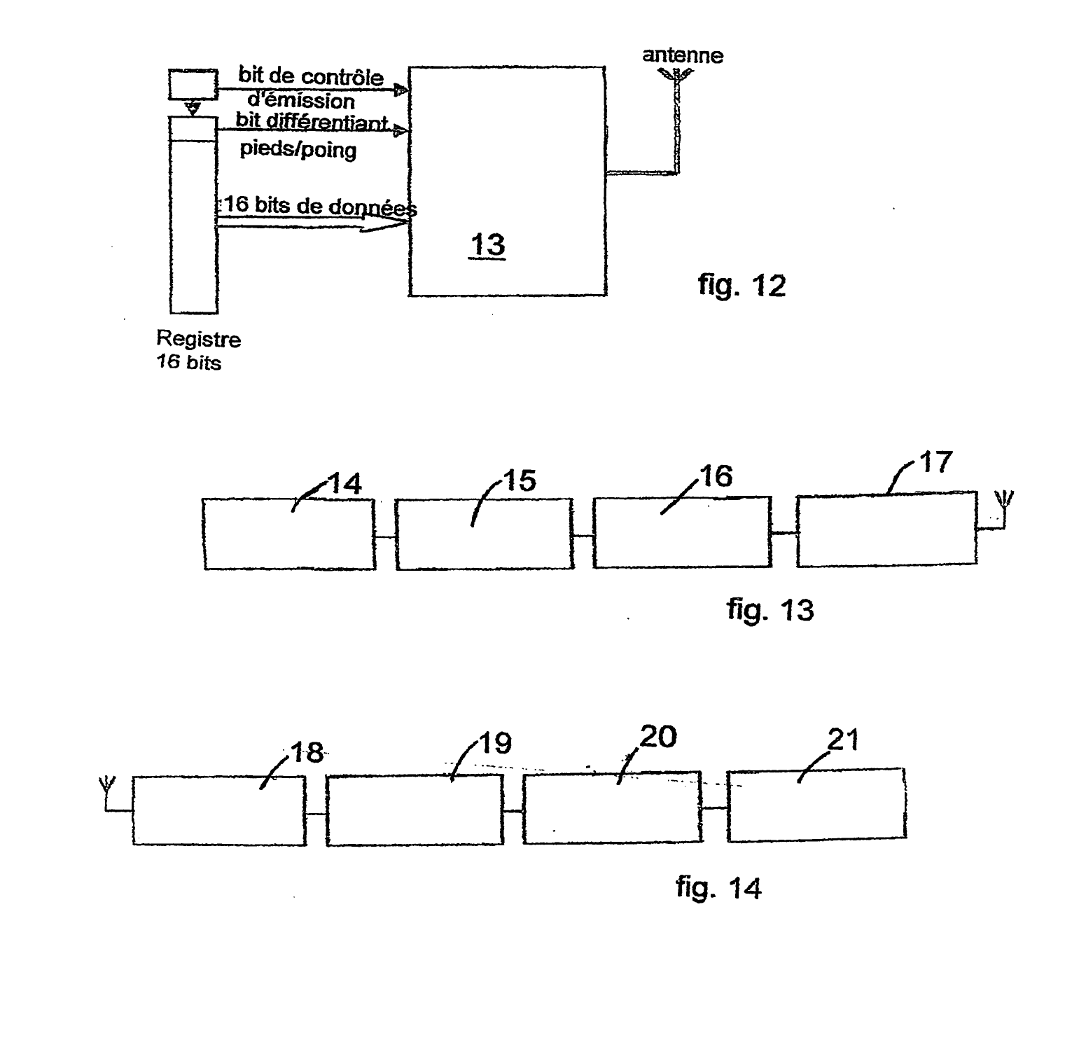

FIG. 13 is a diagram showing the encryption of data;

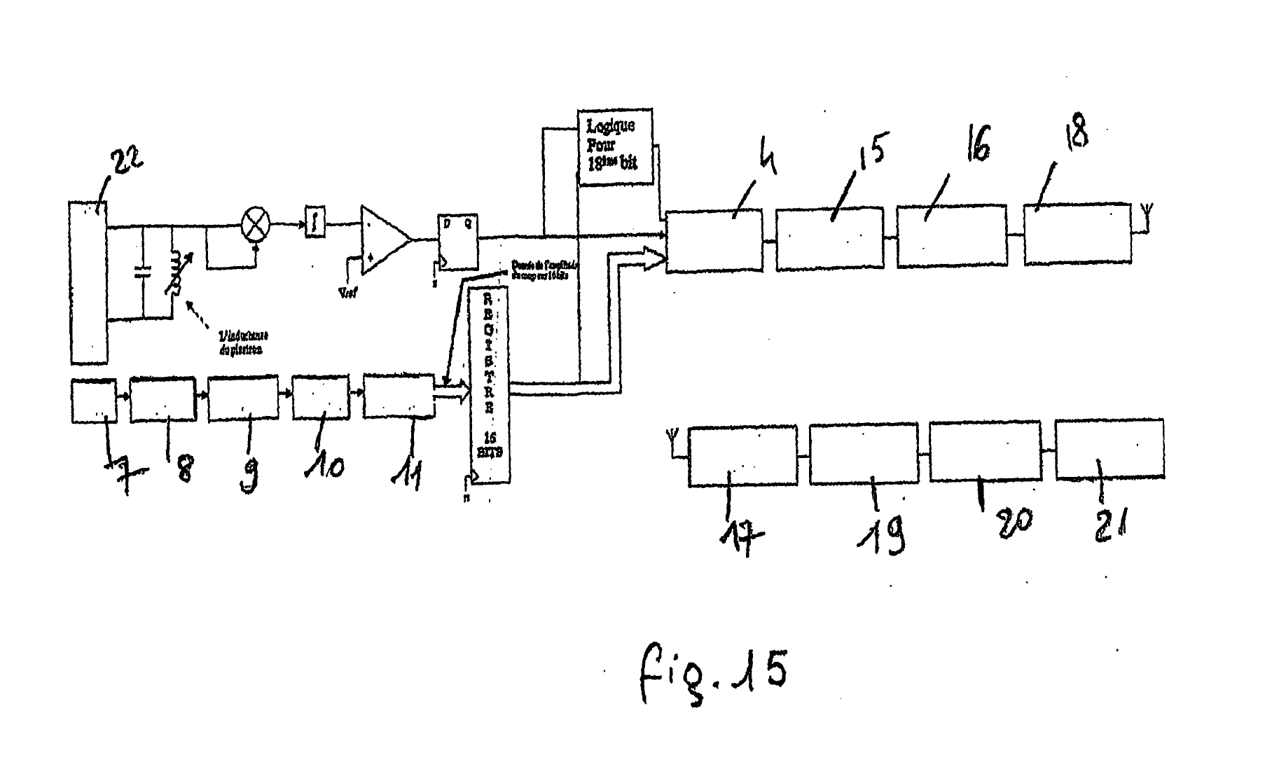

FIG. 14 is a diagram showing the reception of data;

FIG. 15 is a diagram showing the connection between the data receiver and a computer.

In the drawings the references herebelow have the following meaning:
1. Oscillating circuit
2. Target
3. Induction coil
4. Comparator
5. Mobile body
6. AC/DC converter
7. Variable capacity sensor
8. Conditioner, load/voltage converter
9. Low noise amplifier
10. ‘Antialiasing’ filter
11. Sampler/blocker, later CAN
12. Oscillator
13. Emitter
14. Encryption
15. Source encoding
16. Channel encoding
17,18. Device with antenna
19. Amplification and filtering
20. Decoding
21. Display.
   1. Sensors

The aim is to place two sensors. Sensor A must at the same time tell whether a blow has been delivered onto the breastplate or not, and yield an electric image of the amplitude of this blow as delivered. The other sensor, or sensor B, must tell whether the opponent's fist has reached sufficiently near the breastplate. A correlation between the two may thus allow one to distinguish blows as delivered with the fist from kicks. In other words, if only a blow is perceived, but nothing delivered with the fist, then it is a kick, and if only a nearing fist is detected no blow will have been delivered.

Sensor A

The idea is to insert small interconnected plates, or P1, P2, P3, . . . Pn, and P′1, P′2, P′3, . . . P′n, of a conductor metal within the breastplate, with the small metal plates opposing one another. Thus a capacitor matrix M will be formed. One must therefore prepare within the breastplate at least two foam layers, of varying thickness, which will be called sheets. As the two foam sheets F1, F2, will accommodate the metal armatures, they must be specially designed therefor. The conductor metal must be situated inside grooves as arranged in the foam (FIG. 1).

The two foam sheets facing each other are separated by a thinner sheet (not represented), and the foam which makes up the breastplate must be sufficiently rigid not to be too much deformed by the blows. The edges of a thus designed sheet will be in contact and will prevent the armatures from touching each other. In order to increase efficiency at this level, and to form small cells insulating each small capacitor, the grooves are arranged in opposite manner; a given sheet will have its grooves, R1, R2, R3, . . . Rn set in one direction (vertical), and the other will have its grooves, R′1, R′2, R′3, . . . R′n set perpendicularly (horizontal). See FIG. 2 and FIG. 3.

Each of the two armature matrices, the one being placed in a given sheet, and the other in the opposing sheet, in effect forms the armature of a large capacitor. To each of these two matrices charges will be brought by feeding this system with an alternating voltage.

On a given sheet the small metal plates are interconnected as shown in FIG. 4.

Finally when a blow is delivered the structure is deformed as shown in FIG. 5.

As a result the value of the capacitor as formed by the whole system is changed. Indeed, the electric value of a capacitor may be expressed by its capacity C, which may be written thus:

$$C = \frac{{ɛ}_{o} {ɛ}_{r} S}{e}$$

S is the surface area of the armatures
εₒ is the permittivity of the vacuum
εᵣ is the permittivity of the foam between the two armatures
e is the space between the two armatures.

Therefore if the interval between the two armatures varies the capacity of the capacitor also varies. More precisely, when a blow is delivered onto the breastplate, the interval between a part of the matrix M and the opposite part of matrix M′ will decrease, and therefore the capacity will increase. The network of small armatures which was created as shown hereabove forms an enmeshed network of small capacitors, and the total capacitor in the whole breastplate is made up of the sum of these small capacitors. Therefore the total capacity may be written thus:

$$C = {\sum }_{i = 1}^{n} \frac{{ɛ}_{o} {ɛ}_{r} {S}_{i}}{{e}_{i}}$$

Whenever a blow is delivered onto any part of the breastplate, a few small capacitors will experience a change in the interval between the armatures as expressed by eᵢ and therefore the total capacity will also change.

A simple electronic measuring means is arranged in order to obtain a precise image of the amplitude of the force as applied on the breastplate.

Sensor B

This allows one to ascertain whether a blow, more precisely with the fist, has been delivered.

The solution is brought about by electromagnetic means, or more precisely by the fluxgate technique. The aim is to ascertain whether one of the opponent's two fists (or other part of the body) has neared the breastplate.

To carry out this task a fine Mumétal®, also called Permalloy® strip is embedded into gauntlets as worn by the two opponents. The gauntlet may also be fine and not necessarily cover the whole hand—it is but a support for the Mumétal® connecting strip, which, for its part, may perhaps not be more than 1 mm thick. This strip should for instance be arranged facing the first phalanxes.

The Mumétal® or Permalloy®'s main characteristic is to be highly permeable to the magnetic field. It absorbs part of its energy and thus deflects the field lines. Therefore one or several copper coil networks are included into the breastplate, and are fed with an alternating current in order to create a sizeable magnetic field. This magnetic field, being near the breastplate, will be altered by the nearing Mumétal® or Permalloy®. Once the field lines are deflected, a different current will be induced in the coils. An electronic circuit ensures that these coils are fed with a suitable voltage. A change in the current as induced in the coils will change their impedance, a result which it is possible to exploit. One may therefore make use of an oscillating circuit whose variable coil, now represented by the breastplate, will be part of the filter. A fixed capacitor is wired up in parallel, and the whole setting is tuned so as not to disrupt the environment.

Mumétal® and Permalloy® are proprietary trade marks of the Goodfellow company, a corporation with headquarters in the United Kingdom. They are ferromagnetic alloys with high magnetic permeability and low coercive force.

For instance the properties of a Mumétal® having the composition 77% Ni, 14% Fe, 5% Cu and 4% Mo are the following:

| Electric properties | |
|---|---|
| Electric resistivity (μohm · cm) | 55-62 |
| Magnetic properties | |
| Coercivity (Hc) (Am⁻¹) | 1.0 |
| Curie temperature (° C.) | 380 |
| Initial permeability | 60,000 |
| Maximum permeability | 240,000 |
| Residual magnetism as from saturation (Brem) | 0.37 |
| Saturation induction (Tesla) | 0.77 |
| Mechanical properties | |
| Brinell hardness | 105-290 |
| Modulus of elasticity (Gpa) | 190-221 |
| Impact strength (Izod) (J · m⁻¹) | 42-100 |
| Tensile strength (MPa) | 530-900 |
| Physical properties | |
| Density (g · cm⁻³) | 8.8 |
| Thermal properties | |
| Coefficient of expansion at 20-100° C. (×10⁻⁶K¹) | 13.0 |
| Thermal conductivity at RT (Wm⁻¹K¹) | 30-35 |

It must be noted that in the preceding Table the most interesting figure is naturally the permeability under the heading ‘magnetic properties’.

Thus the magnetic properties of the target are detected with a magnetic field detector. The aim is to position the target 2 to be studied near the inductance of an oscillating circuit 1. If the target is a magnetic one, its presence will change the impedance of the coil and thus the resonance parameters of the oscillating circuit, that is to say the frequency and amplitude of the obtained wave. One selects for instance a Colpitt type oscillating circuit 1 whose transfer function is known. In effect the choice as implemented for constructing the magnetometer is that of a simple oscillator, built with an reversing switch, a capacitor and a resistance. Then an induction coil and another capacitor are added in order to be able to vary the oscillating frequency and the amplitude of the wave which is obtained when a magnetic item is brought near the induction coil. The induction coil 3 will be the coil as embedded in the breastplate. Thus bringing the Mumétal® strip 5 near the induction coil 3 will change its impedance as well as the frequency and amplitude of the wave as produced by the oscillating circuit 1. It is thus possible to detect the presence of the Mumétal® strip 6 by simply varying frequency, through the use of a phase locking loop. However, considering it is much simpler to detect amplitude variations, this was the choice implemented. Then a comparator 4 is used to compare to a pre-established reference voltage the peak value of the wave as obtained from the oscillator. FIG. 6 shows a block diagram of the magnetometer, wherein one may note that the output signal from the oscillator is first converted with a diode and a capacitor (converter 6) in order to facilitate a comparison between DC tensions.

One will only need later on to memorise the comparator output in a latch in the shape of a logical level.

1. Data Acquisition

Sensors A and B are therefore respectively made up of a variable capacitor and a variable induction coil. The resulting two items of information are transformed into a 16 bit digital signal for instance. It must be noted that one bit only is necessary to detect whether a fist is present or not on the breastplate.

a. Amplitude of a Blow

The acquisition of a capacity variation, which is the amplitude of a blow as delivered onto the breastplate, is the subject of a quite conventional acquisition chain (see FIG. 7).

It must be noted that for a maximum integration and therefore to save space the project specification concerning the variation frequency of the capacitor and the optimum number of bits must be precise. It is to be expected that the operating frequency will be low and that it will be possible to manage without such a high number of bits, with, as a result, the important consequence that a track and hold unit for instance will be unnecessary, or that it will not be necessary to design an excessively costly low noise highly efficient amplifier. Naturally the same also holds for the anti-aliasing filter.

Considering the problem as a whole, microelectronics is seen as the obvious solution. It is therefore recommended to choose a wiring system with gated capacities for the filters and possibly a ΣΔ converter for the analog-to-digital converter.

Example of an Integrated Solution for the Interface:

To give an example of a feasible microelectronics solution, we shall present a part acting as an interface between the sensor and the remaining electronic circuits, viz. the load/voltage converter.

FIG. 8 shows the electronic system as associated with the sensor. OP2 is an output buffer which allows one to load an exterior component. OP1 is used as a load/voltage converter.

In order to compensate for the sensor offset and gain errors, use is made of a double differential element which comprises two capacitances. One is used as a reference and is covered with a fine oxide layer \textcircled{C}_{ref} and the other is the sensitive element \textcircled{C}ₛₑₙₛₒᵣ, that is to say the breastplace capacitance as hereabove described. The gated capacity circuit from Cₛₑₙₛₒᵣ to C_{ref} forms a non inverter amplifier, whereas the circuit from C_{ref} to C₁ is an inverter amplifier. The transfer function for this circuitry is the following

$${V}_{out} = {V}_{Ref A} ( \frac{{C}_{sensor}}{{C}_{1}} ) - {V}_{ref B} ( \frac{{C}_{ref}}{{C}_{1}} )$$

wherein V_{refA} and V_{refB} may be used to adjust the output offset as caused by a discrepancy between Cₛₑₙₛₒᵣ and C_{ref}. The circuit's response time is given by the time constant:

$$τ = \frac{1}{{f}_{c}} \frac{{C}_{2}}{{C}_{1}}$$

wherein f_{c} is the clock frequency.

According to the transfer function, Vₒᵤₜ, varies linearly according to Cₛₑₙₛₒᵣ. The timing diagram below the circuitry shows how necessary it is to have non overlapping clocks.

Following the CAN, data will have to be memorised in a 16 bit register. Thus the necessary information will be available in parallel, ready to be used by the transmitter.

b. Presence of the Fist on the Breastplate

As hereabove mentioned, the aim is to store a bit as memorised in a latch with a low level if the fist is present and a high level otherwise. The inductance as represented by the breastplate varies with the presence of the Mumétal® strip and therefore the amplitude of the signal, as well as its frequency, will vary likewise. This is what one tries to detect. It must be noted that the chain as suggested herebelow may be calibrated by varying V_{ref}. In other words the system may react to a greater or smaller vicinity to the breastplate according to V_{ref} which therefore represents a detection threshold. However, notably to avoid problems arising from noise, it is preferred to multiply the frequency output from the oscillator and then to filtrate the part which is to be singled out (FIG. 9).

The signal before the multiplier may be written:
V=Aₒ sin ωₒt
wherein Aₒ is the amplitude.

After the multiplier comes the signal:

$${V}^{2} = {A}_{0}^{2} \frac{1 - cos 2 {ω}_{o} t}{2} = \frac{{A}_{o}^{2}}{2} - \frac{{A}_{o}^{2}}{2} cos 2 {ω}_{o} t$$

It is precisely this amplitude which is to be compared with V_{ref}. At rest, in the absence of any Mumétal®, this amplitude must be slightly higher. The comparator is fed between 0 and V∞(for instance 5 V or 3.3 V), and therefore at rest 0 V will appear as the comparator output. When the Multimétal®—simply by being present—changes the inductance, the amplitude Aₒ²/2 decreases, and therefore, as from a calibrated threshold, V_{ref} becomes higher, and the output will be V_{∞}. This comparator output is memorised.

Example of an Integrated Solution for the Multiplier

As to the multiplier, one may for instance suggest a simple Gilbert cell as shown in FIG. 10. The output, which is the signal from the oscillator as multiplied by itself, is the difference between voltages at the terminals of the two resistors. The arrangement may be refined when the two fighters are equipped with systems which react to varying thresholdings, coupled with Mumétal® strips having different characteristics. In effect, if the defendant for instance falls to the ground with his face forward, one of his hands being near the breastplate, the solution according to the state of the art is to detect a blow delivered with the fist. Now the present paragraph 12) quotes an example giving characteristics of Mumétal® wherein one can see that it is possible to set various permeabilities for this alloy. A more thorough study shows that it is easy to make good use of this feature to solve the problem. Briefly, one may however add that the two electronic systems may work at different frequencies. One might even distinguish between each of the four hands which are present on the tatami.

c) Preparation of Data

The binary information relating to the amplitude of a force as delivered onto the breastplate being on 16 bits and the data concerning the presence of one of the opponent's hands being on a single bit, the data will have to be transmitted on 17 bits.

Moreover the system which exploits data, for instance a computer software, will not only have to decrypt a blow delivered with the fist if a blow is detected on the breastplate, together with one of the opponent's hands—it will also have to interpret a kick as a blow delivered onto the breastplate, as well as the absence, or more precisely the lack of presence, of the opponent's hand. Keeping in mind that data need only be transmitted in these two cases, mainly in order not to waste the electrical energy associated to an transmission, a logical signal is worked out to give notice to the transmitter that it may transmit data as present in the registers. See FIG. 11.

3. Transmission-Reception

a. Transmission

The information signal is stored in a 16 bit register which allows one to encode the strength of the blow as delivered onto the breastplate. One bit allows one to differentiate between a blow delivered with the fist and a kick.

An additional bit allows one to define the moment in time when the signal is emitted towards the receiver system. The consumption of a system which emits on an antenna is important. It is therefore necessary—in order to maintain a degree of autonomy—to reduce to a minimum the time interval for transmitting the signal. This control bit has a zero initial value. This switches to one when a blow delivered with the fist (respectively a kick) is detected at the comparator level (respectively at the CAN level), and returns to zero once the signal is transmitted. See FIG. 12.

To the 17 bits to be emitted may be added bits which allow one to customise the transmitter in order to be able to use several systems. Another solution is to turn to an already existing multi-user system (e.g. bluetooth). An encryption device may be added before the transmitter besides the equalization system. This will allow one to secure the radio communication with the receiver device. The underlying principle relies on changing the binary sequence by multiplying it by a pseudo-stochastic sequence called a key.

Many types of encryption exist nowadays. Therefore the insertion of such a system before transmission is in no way difficult.

The encrypted binary sequence which comprises the strength of the blow and its origin (fist or kick) must then be processed in order to add redundancy. This is conventionally a code for correcting errors. In effect, during a radio transmission, the signal may be garbled by the air as a propagation channel. It is therefore necessary to protect the bits of information with an encoding system whose main property is to detect transmission errors and to correct them in given circumstances.

Should this processing present one with major implementation difficulties, one might choose a conventional line code. Indeed, considering the small number of blows delivered in relation to the operating frequency of the system, the relevant information might be transmitted several times in order to avoid errors as caused by transmission. See FIG. 13.

The 16 bit output of the parallel register must be sent in sequence to the transmitter in order to implement the various processes which are necessary for encoding. A first encoding, or source encoding, allows one to add redundancy to the signal as hereabove mentioned.

The channel encoding allows one to increase the frequency of the transmitted signal. This frequency is standardised for very small distance communications. One might for instance adopt a frequency of 433 MHz, which is used for infrared remote control, or a frequency of 2.4 GHz, which corresponds to the Bluetooth standard. More generally several standards are to be found in the 2.4 GHz band. The other benefit resulting from this encoding is to reduce spectrum width thanks to a formatting filter.

The obtained signal is then transmitted through the antenna by radio waves. A particular study will perhaps be necessary for dimensioning and choosing the antenna.

b. Reception

Reception is carried out in a conventional way. An antenna collects the signal as sent by the system which is embedded in the breastplate. This signal is then amplified and filtrated in order to restore it. A decoding system is provided after the signal has been restored in baseband form. If an encryption operation has been decided, a decryption will have to be implemented. The relevant information is then transmitted to a computer or a display device especially created for this system. See FIG. 14.

The most flexible solution is to connect the receiver to a computer which then converts the received signal into a strength as delivered by a fist or by a kick through a computer program. See FIG. 15.

1.-10. (canceled)

11. Apparatus for detecting presence and measuring strength of an impact of a blow struck by a mobile body on a mobile or stationary target, comprising a first sensor integral with the target for detecting whether the target has been impacted by the mobile body and producing an electric image of the impact, the first sensor comprising a variable capacitor, and a second sensor integral with the mobile body for detecting whether the mobile body grazes the target or strikes it, the second sensor comprising a variable induction coil.

12. Apparatus according to claim 11, wherein the target comprises means for creating a magnetic field in its vicinity, the mobile body comprises a material highly permeable to the magnetic field and the apparatus further comprises a magnetic field detector for detecting magnetic properties of the target.

13. Apparatus according to claim 12, wherein the material highly permeable to the magnetic field comprises at least one ferromagnetic alloy having a high magnetic permeability and a low coercive force and has a permeability of 60,000 to 240.000.

14. Apparatus according to claim 13, wherein the material permeable to the magnetic field comprises a Mumétal® or Permalloy® alloy.

15. Apparatus according to claim 12, wherein the magnetic field detector comprises an induction coil, an oscillating circuit, a converter and a comparator, the magnetic field detector detecting variation of the magnetic properties of the target induced by a material which is permeable to the magnetic field.

16. Apparatus according to claim 11, wherein the first sensor comprises at least one matrix including a plurality of capacitors, the at least one matrix being partially deformable under the influence of an impact thereby to vary conductance of a circuit including the capacitors.

17. Apparatus according to claim 16, wherein the at least one matrix comprises a first matrix including a first plurality of interconnected plates of a conductor metal and a second matrix including a second plurality of interconnected plates of a conductor metal, respective plates of the first plurality of plates facing respective plates of the second plurality of plates and the deformation of the matrixes under the influence of an impact varying distance between respective pairs of the facing plates thereby to vary conductance of a circuit including the pairs of the facing plates.

18. A method for detecting nature of an impact of a blow struck by a mobile body on a mobile or stationary target, comprising creating a magnetic field on the target, providing a first sensor comprising a variable capacitor integral with the target for detecting whether the target has been impacted by the mobile body and producing an electric image of the impact, wherein impact of the mobile body on the capacitor varies capacity of the capacitor, providing a second sensor comprising a variable induction coil integral with the mobile body for detecting whether the mobile body grazes the target or strikes it, wherein variation of strength of the magnetic field varies inductance of the induction coil, memorizing the capacity variation in a 16 bit register, and memorizing information about the inductance variation by one bit in a low level latch if the mobile body is present and in a high level latch if the mobile body is absent.

19. A method according to claim 18, comprising transmitting respective data of the capacity variation and of the inductance variation in the form of signals by means of radio waves to a receiver connected to a computer.

20. A method according to claim 18, wherein the blows are struck in combative sport and the computer processes said data to produce information for assisting refereeing of the combative sport.

21. A method according to claim 20, wherein the combative sport is taekwondo.
